(19) United States
(12) Patent Application Publication
(10) Pub. No.: US 2023/0381667 A1
(43) Pub. Date: Nov. 30, 2023

(54) Methods and Related Systems for Hosting Game Hunting and Fishing Tournaments

(71) Applicant: Adam Gene Munsterman, Kearney, MO (US)

(72) Inventor: Adam Gene Munsterman, Kearney, MO (US)

(21) Appl. No.: 17/826,253

(22) Filed: May 27, 2022

(51) Int. Cl. A63F 13/798

(52) U.S. Cl. CPC A63F 13/798; A63F 2300/558

(57) ABSTRACT

The present disclosure provides a computer-implemented method and online platform for hosting one or more game hunting and fishing tournaments between users registered on a database. Participants of different skill levels are divided such that they can compete and compare themselves against those of a similar skill level using a threshold point range mechanism. The method thus facilitates the hosting of objectively fair local tournaments between acquaintances, focused on specific target primary species, and using predefined rulesets and scoring systems, such that the skill levels of tournament participants can be accurately tracked and reflected without excluding those of lower skill, and rewards can be calculated and allocated in a fair manner.

### FIELD OF INVENTION

The present invention relates generally to online hosting platforms and software. More specifically, the present invention relates to a computer-implemented method for facilitating online hosting of local tournaments in a fair manner.

### BACKGROUND

Game hunting and fishing tournaments have been prevalent throughout human history, with individuals competing against one another to capture animal specimens of large size and stature, or which are impressive in some other objectively measurable way. The winner is the one who catches the most impressive specimen, and they often receive a reward, such as prize money.

In the current day, this practice still thrives, however due to globalisation such tournaments are extremely competitive, no longer restricted to local communities and not suitable for hobbyists or more casual hunters. A large proportion of the hunting population thus does not engage with competitive hunting, because they would have little to no chance of winning.

It would be desirable for a platform to exist that facilitated the hosting of smaller competitions by local communities so that friends and acquaintances could test their skills against one another, while still facilitating objective and fair evaluations of skill. It is within this context that the present invention is provided.

### SUMMARY

The present disclosure provides a computer-implemented method and online platform for hosting one or more game hunting and fishing tournaments between users registered on a database. Participants of different skill levels are divided such that they can compete and compare themselves against those of a similar skill level using a threshold point range mechanism. The method thus facilitates the hosting of objectively fair local tournaments between acquaintances, focused on specific target primary species, and using predefined rulesets and scoring systems, such that the skill levels of tournament participants can be accurately tracked and reflected without excluding those of lower skill, and rewards can be calculated and allocated in a fair manner.

Thus, according to one aspect of the present disclosure there is provided a computer-implemented method for hosting game hunting and fishing competitions, the method comprising the steps of: storing user data for a plurality of users of a game hunting and fishing tournament platform in a database; receiving a tournament request from one or more first users to host a local tournament, each tournament request comprising a primary target species and a set of pre-defined rules and scoring thresholds.

The method then comprises generating a tournament scoreboard having an associated tournament ID for each tournament request, and assigning permission to the host of each respective tournament to administrate entry of one or more second users into their tournament scoreboard; calculating a set of rewards for each tournament scoreboard based on the pre-defined scoring thresholds and the number of participants in each tournament scoreboard; receiving one or more score entries from the one or more second users and participating in each tournament scoreboard; calculating a points score for each second user based on the received score entries and the pre-defined rules for their respective tournament scoreboard and ranking the second users within each tournament scoreboard; determining that a predefined time period for the one or more competitions has ended; and determining a distribution of rewards for each tournament scoreboard based on the rankings of the second users and the pre-defined scoring thresholds.

In some embodiments, the method further comprises using the scoring thresholds to define two or more classes within each tournament scoreboard, with a predefined reward allocation being made available within each class.

In such embodiments it may also comprise receiving a class selection from each second user upon entry to a given tournament scoreboard. Then, at the end of the predefined time period, it may comprise determining whether each second user has met the score threshold of their selected class, and if they have not met the score threshold, assigning them a lower class for a subsequent time period and marking them as ineligible for receiving reward allocations in that time period and/or determining whether each second user has exceeded a threshold score range for their selected class in that time period and, if they have exceeded the threshold score range, assigning them a higher class for a subsequent time period.

In some embodiments, the pre-defined rules in each tournament request comprise rules designating methods for calculating points based on a body part of a captured animal of the primary species.

In some embodiments, the pre-defined rules in each tournament request comprise rules designating methods for verifying the accuracy of results submitted by one or more second users.

In some embodiments, the method further comprises receiving one or more weapon selections from the one or more second users for the pre-defined time period. It may then comprise applying a multiplier to the score of each second user having submitted a weapon choice for that time period, the multiplier being based on a weapon databases listing a number of different weapons having associated multipliers based on their difficulty of use.

In some embodiments, the method further comprises receiving from the one or more second users additional information relating to hunting activities relating to animals which are not of the primary target species for the tournament scoreboard in which they are participating.

In some embodiments, the method further comprises providing a user interface for the one or more second users for each tournament scoreboard, where they may view a portion of the user data associated with the other second users participating in a shared tournament scoreboard.

The user interface may also show the region and location of the host of the tournament scoreboard; a scoring threshold and ranking of the user for that tournament scoreboard; and reward distribution amounts for the tournament scoreboard based on the scoring threshold associated with the second user and their current score.

In some embodiments, the method further comprises storing each second user's tournament history in the user database and providing a user interface where the one or more second users may view their tournament history. The method may also involve awarding virtual badges and trophies to the one or more users upon satisfaction of predefined conditions, the virtual badges and trophies being viewable via the user interface.

In some embodiments, the method further comprises providing a user interface where second users participating in tournament scoreboards having two or more participants and meeting one or more predefined conditions may view scores and rankings of participants of other tournament scoreboards associated with larger regions.

### BRIEF DESCRIPTION OF THE DRAWINGS

Various embodiments of the invention are disclosed in the following detailed description and accompanying drawings.

FIG. 1 illustrates a first example user interface on a user device for a user to interact with the hosting method of the present disclosure.

FIG. 2 illustrates a second example user interface on a user device for a user to interact with the hosting method of the present disclosure.

FIG. 3 illustrates a third example user interface on a user device for a user to interact with the hosting method of the present disclosure.

FIG. 4 illustrates an example scoring guide method for evaluating a captured specimen of a first species class and converting measurements of the specimen into a points score.

FIG. 5 illustrates an example scoring guide method for evaluating a captured specimen of a second species class and converting measurements of the specimen into a points score.

FIG. 6 illustrates an example scoring guide method for evaluating a captured specimen of a third species class and converting measurements of the specimen into a points score.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

A set of example operations for hosting game hunting and fishing tournaments between users of a platform will now be described.

One or more of the operations and calculations described herein may be performed by a cloud infrastructure comprising one or more servers and databases. This is merely an example infrastructure however, the servers need not necessarily be cloud-based. The cloud infrastructure may for example comprise a database configured to receive and store multimedia content and user data for a plurality of user accounts and a set of connected servers or nodes configured to enact the operations as disclosed herein.

The cloud infrastructure is configured to communicate with a set of client devices by various means over the network architecture. The client devices include devices configured to communicate with the cloud infrastructure via a communications tower. These devices may include but are not limited to a smartphone, a laptop, and a tablet computer.

Additional client devices configured to communicate with the cloud infrastructure via a networked computer modem include but are not limited to a smart display. Some of the connections may be wired connections, such as the connection between the smart display and the networked computer modem.

Any one of the client devices may be operationally coupled to a wide area network (WAN) such as the Internet with a wireless connection. The wireless clients may be communicatively coupled to the WAN via a Wi-Fi (or Bluetooth) access point that is communicatively coupled to a modem, which is communicatively coupled to the WAN. The wireless clients may also be communicatively coupled to the WAN using a proprietary carrier network that includes communication tower.

While a specific set of client devices are listed as examples of the architecture, the client devices may in fact be any suitable device. For example, client devices could include a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

Each client device may be associated with or “logged in” to a user profile in order to operate within the disclosed system and method, and further configured to send requests, upload user data, and generally interact with the cloud infrastructure via a user interface displayed on the device.

After logging in, a user will arrive at a home screen of a hosting platform. At the Home-Screen the guest should be able to pick if they want to Host a tournament (which in the present description is referred to as a “Camp”.

If they choose to Host a Camp, their Hosting information will populate into a database of available Camps to Join. Hosting information (may be different from their personal residence or personal information as the hosting information should be the actual location of the Camp or location that the host might wish participants to come for verification of scores) should include the Host's name, Host Address, Host City, Host State, Host Zip Code, Host County, Host Phone Number, Host Email Address, Name of the Camp, Species of Game, Scoring Criteria, Entry Fee Amount and the Estimated Number of Participants.

The game host chooses a Primary Game Species. They may also choose an Entry Fee dollar amount which contributes to the rewards which will be allocated to winners of the camp. They also choose the scoring system, so that the rules by which participants are scored for their catches are pre-defined. The scoring system will be divided into classes with number ranges—participants of the camp will select a class to be scored in upon joining and will compete with other participants who have selected that class. Each class has an associated points number range, with the lower number of the range being labelled a qualification number that the participant must meet to be eligible for reward distributions. This entire process establishes a “Camp Host.

If they choose to Join an existing Camp, they will enter their participant information and their information will populate the Overall Participant Database. They may need a specific invitation from a host to join an existing camp, and will always at least need approval of the host for their joining request. Upon joining a camp they are sent to a virtual room associated with the camp they have joined.

Once the participant has joined the camp they will be able to see annual game information for that camp and access to that camp's scoreboard, rankings, and Game Registration List which includes contact information of the individuals within that Camp. The Game Registration List will also include each participants designated Class.

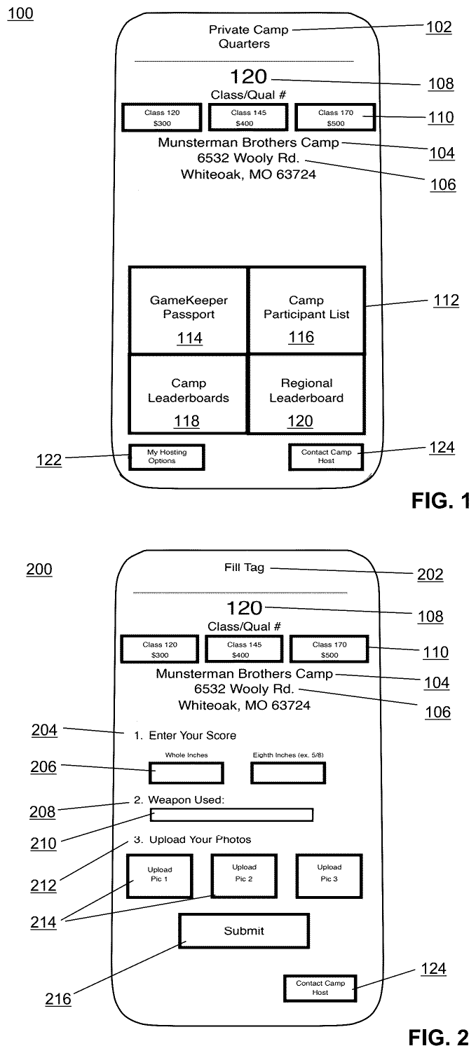

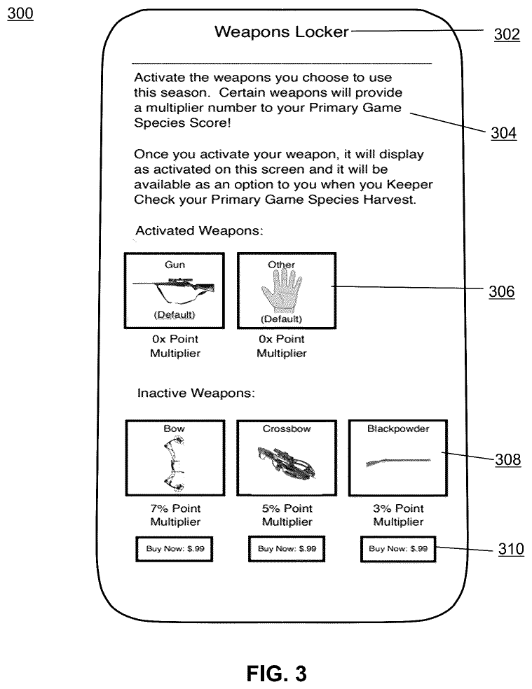

Referring to FIG. 1, FIG. 2, and FIG. 3, a set of example user interfaces are shown on a user device for a user to interact with the hosting method of the present disclosure.

FIG. 1 shows a first user interface 100 for a participant who has joined a camp. The interface has an indicator 102 that this is a camp UI, a title 104 of the camp, and contact details 106 of the camp host.

Upon joining the participant would have chosen a class from a number of classes (for example three classes per camp) and their chosen class and the lower number of the class range which is also their qualification number 108 will be shown in the UI. The different classes for a camp and their associated reward allocation 110 may also be shown.

The Participant will have an interface 112 for accessing various aspects of the camp in this UI as well. This includes a gamekeeper passport 114 with relevant details and where they can enter tags with details of their animal captures, the camp participant list 116, the camp scoreboard/leader board 118, and a regional scoreboard 120 where they can view rankings and points of other camps across the nation.

If the user is the host of the camp they will also have access to a hosting administration page 122, and if they are not the host they will have access to an interface for contacting the host 124.

Referring to FIG. 2, a second UI 200 is shown for a tags page 202 accessible by clicking the gamekeeper's passport where the user is able to view his/her available Tags, add new tags, and enter the scores for their tags. This will still be associated with a certain camp, so information relating to the user within that camp is still shown including camp name 104, camp address 106, class and qualification number 108, class ranges and rewards 110, and the ability to contact a camp host 124.

In addition, a variety of options are available for a user to enter score data 204, and measurements determining the score data 206. There is a weapons used section 208 with a drop down box 210 for selecting a weapon from a list. This weapon selection may only be available if a user has access rights to that weapon, and may be used as a multiplier for modifying a user's score based on the difficulty of the weapon. There is also a section for a user to upload images of their catch 212, with one or more slots 214 for uploading the images. Finally, there is a submit button 216.

In some examples, the participant may only get one chance to enter his/her score and upload photos. In other examples, the participant might have more than one opportunity to enter their Score. This will depend on the selected Primary Game Species for a given camp. If the Primary Game Species is large Game, the Host will usually get to determine how many chances the participant have to achieve their best result. Fish are generally different. If the primary species is a fish species then participants will be allowed to enter and continuously update a score with a larger Fish if they continue fishing throughout the tournament. Waterfowl are also different. The participant is allowed to enter their score and those numbers will accumulate so that every time they enter a score, they are increasing their points.

In some examples, three photos will be required for each capture Tag. Upon hitting the submit button, a notification with their score and pictures may be sent to each Camp Participant, including the Camp Host and is also sent to populate a Tag Database. The score and participant info should populate into an Overall Scoreboard. The scoreboard will then determine if their score Qualifies. In order for the score to qualify, it has to be equal to or greater than their designated Class Number.

In addition, the score populates a memory section back at the participant's home screen which contains their hunting history, badges, trophies, etc across their lifetime use of the system. For example, the top three Leaders of every Class in a camp may receive a Virtual Medal. Once it is determined that a participant has placed in such a position, their user data and thus their “trophy cabinet” will be updated with the appropriate medal.

If a participant they scores above their class range, for example if they chose Class 120, which has a range of 120-144, and they score 145, then they get automatically enrolled into a higher class for the following year competition time period. They cannot choose their Class the next year, but are automatically enrolled in the 145 Class.

The Camp Host may have an option to modify a participants score, but only by sending an email to the participant which includes the modified score and an option for the participant to Approve the Modification. The only way for a participant to modify his/or her score in the case where a mistake was made will be for the participant to email the host and request a modification.

Now that the participant has a qualifying score, they are added to the scoreboard of their Class. Their scoreboard should indicate the overall rewards for their Class. The Scoreboard keeps track of the participants score and makes available the photos that were uploaded with the submission. It also indicates if the score has qualified the participant for the Scoreboards. It does not necessarily need to be available for viewing by any of the participants.

As mentioned, there are scoreboards for each class, with users ranked based on their submitted score within each class. The system may be able to search the database of Camp Participants from the previous hunting period, and upon the Participant Joining the Camp again for the current time period, the system will need to determine if the Participant was Classed-up and if so, what Class.

A camp score may also be calculated for each camp based on the highest scorers of each class, which is then uploaded to a database having rankings and scoreboards for each of the County, State and National Scoreboard Databases. These Databases will determine the leaders by the registered Camp County, the registered Camp State and the registered Camp Country. These rankings do not lead to reward distribution, but do generate virtual trophies etc.

Referring to FIG. 3, a UI 300 is shown with a weapon page 302 where a user may activate weapon selection choices for applying modifiers to their scores. A text explanation 304 is given at the top of the page, followed by a list of currently activated weapon modifiers 306 for the user.

Weapons that are available but the user does not actually have access to yet are shown in the inactive weapons section 308, accompanied by the option to purchase those weapons 310. Once purchased the weapons will be added to the user's data, and will be available to apply when submitting their tags.

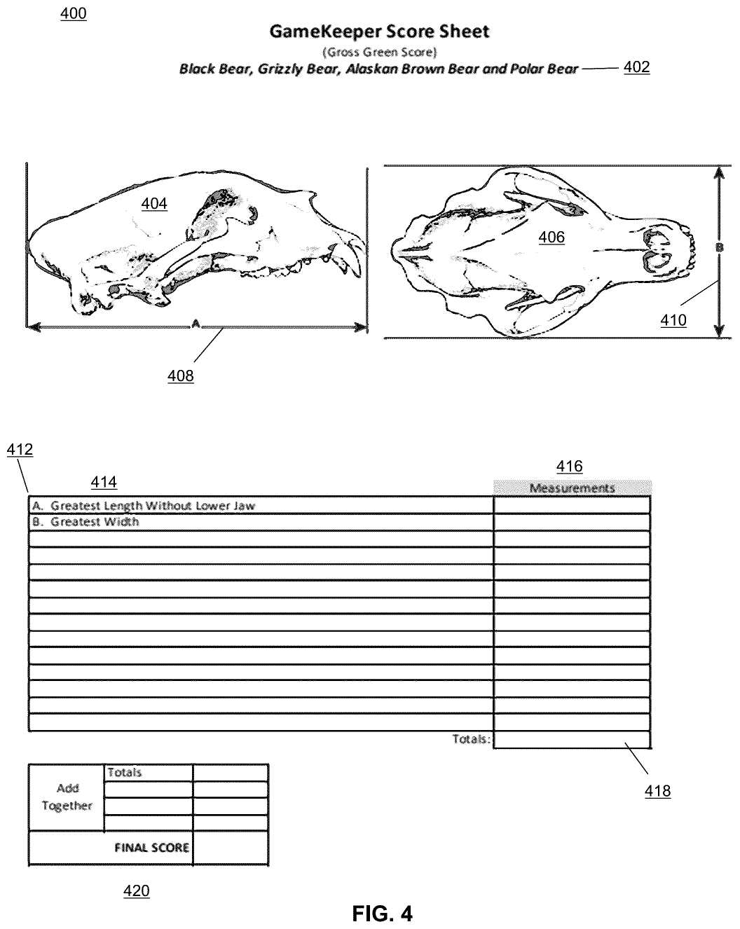

FIGS. 4-6 show example scoresheets for calculating the points contributed for a tag of a given species or selection of species of animal. These scoresheets make up a portion of the pre-defined rules for each camp, as selected and determined by the host when they choose the primary target species for the camp and the accompanying rules.

In practice, the scoring methods of these scoresheets will be incorporated into a software algorithm that is used for determining the layout and calculation methods of the tag input UI as shown in FIG. 2.

FIG. 4 illustrates an example scoring guide 400 with a label 402 indicating the guide is for evaluating a skull from a Black bear, grizzly bear, Alaskan bear, or polar bear, and determining a point score for the specimen.

Illustrative diagrams of the side 404 of the skull and the top 406 of the skull, as well as accompanying guide measurements 408 and 410 are shown. Below these is an entry table 412 with a column 414 for the measurement types and a column 416 for the measurement values. A total value of the measurements 418 is placed on the bottom row. This is accompanied by a scoring table 420.

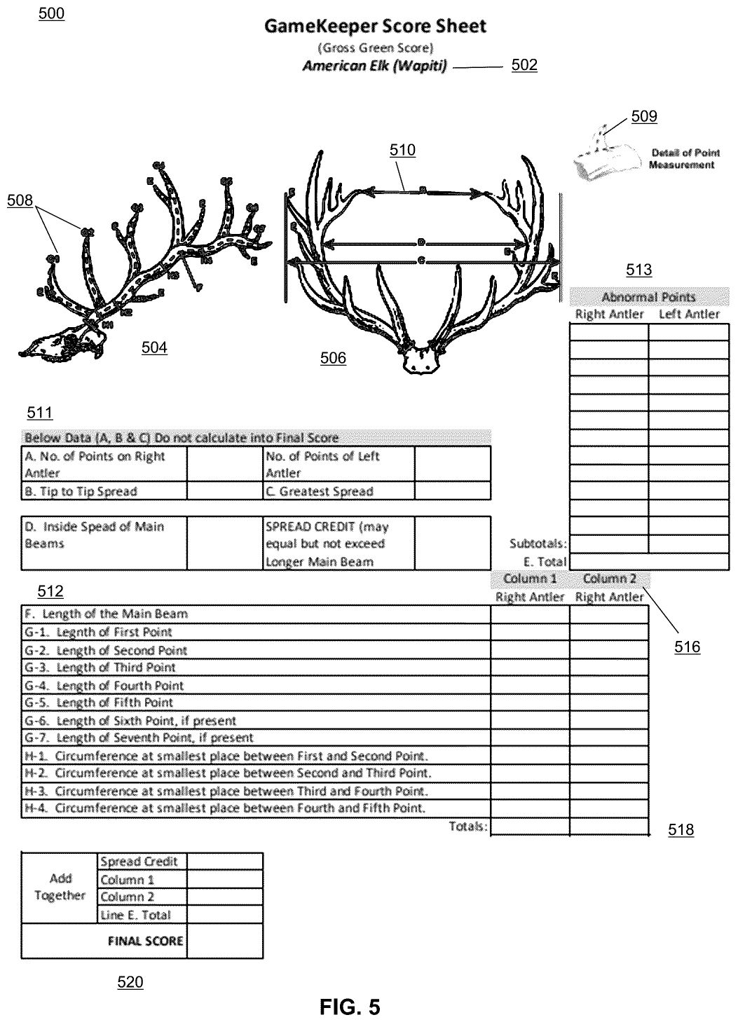

FIG. 5 illustrates an example scoring guide 500 with a label 502 indicating the guide is for evaluating an antler set for an American elk, and determining a point score for the specimen.

Illustrative diagrams of the side 504 of the antler set and the front 506 of the antler set are provided, as well as accompanying guide measurements 508, 509, and 510. Below these are a set of entry tables 511, 512, and 513, with a columns for the measurement types and columns for the values of each antler 516. A total value of the measurements 518 is placed on the bottom row. This is accompanied by a scoring table 520.

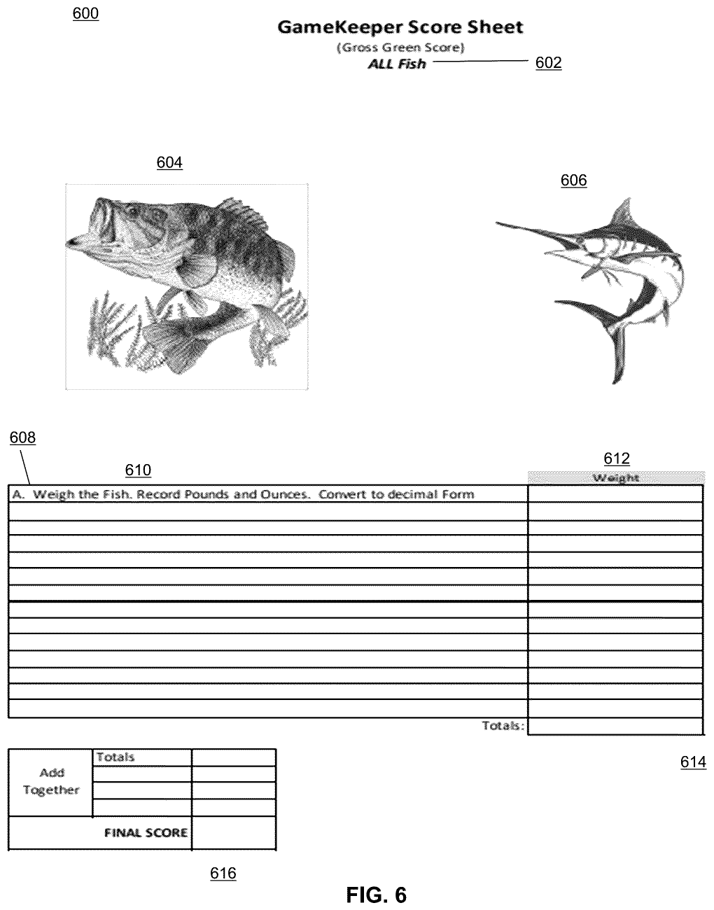

FIG. 6 illustrates an example scoring guide 600 with a label 602 indicating the guide is for evaluating a fish specimen, and determining a point score for the specimen.

Illustrative diagrams of a first fish type 604 and a second fish type 606 are provided. Below these is an entry table 608 with a column 610 for the measurement types and a column 612 for the measurement values (the measurements being in weight rather than size dimensions in this case). A total value of the measurements 614 is placed on the bottom row. This is accompanied by a scoring table 616.

It should be understood that the operations described herein may be carried out by any processor. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining” “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and related systems have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for hosting game hunting and fishing competitions, the method comprising the steps of:
storing user data for a plurality of users of a game hunting and fishing tournament platform in a database;
receiving a tournament request from one or more first users to host a local tournament, each tournament request comprising a primary target species and a set of pre-defined rules and scoring thresholds;
generating a tournament scoreboard having an associated tournament ID for each tournament request, and assigning permission to the host of each respective tournament to administrate entry of one or more second users into their tournament scoreboard;
calculating a set of rewards for each tournament scoreboard based on the pre-defined scoring thresholds and the number of participants in each tournament scoreboard;
receiving one or more score entries from the one or more second users and participating in each tournament scoreboard;
calculating a points score for each second user based on the received score entries and the pre-defined rules for their respective tournament scoreboard and ranking the second users within each tournament scoreboard;
determining that a predefined time period for the one or more competitions has ended; and
determining a distribution of rewards for each tournament scoreboard based on the rankings of the second users and the pre-defined scoring thresholds.

2. A computer-implemented method according to claim 1, wherein method further comprises using the scoring thresholds to define two or more classes within each tournament scoreboard, with a predefined reward allocation being made available within each class.

3. A computer-implemented method according to claim 2, wherein the method further comprises receiving a class selection from each second user upon entry to a given tournament scoreboard.

4. A computer-implemented method according to claim 3, wherein the method further comprises, at the end of the predefined time period, determining whether each second user has met the score threshold of their selected class, and if they have not met the score threshold, assigning them a lower class for a subsequent time period and marking them as ineligible for receiving reward allocations in that time period.

5. A computer-implemented method according to claim 3, wherein the method further comprises determining whether each second user has exceeded a threshold score range for their selected class in that time period and, if they have exceeded the threshold score range, assigning them a higher class for a subsequent time period.

6. A computer-implemented method according to claim 1, wherein the pre-defined rules in each tournament request comprise rules designating methods for calculating points based on a body part of a captured animal of the primary species.

7. A computer-implemented method according to claim 1, wherein the pre-defined rules in each tournament request comprise rules designating methods for verifying the accuracy of results submitted by one or more second users.

8. A computer-implemented method according to claim 1, wherein the method further comprises receiving one or more weapon selections from the one or more second users for the pre-defined time period.

9. A computer-implemented method according to claim 8, wherein the method further comprises applying a multiplier to the score of each second user having submitted a weapon choice for that time period, the multiplier being based on a weapon databases listing a number of different weapons having associated multipliers based on their difficulty of use.

10. A computer-implemented method according to claim 1, wherein the method further comprises receiving from the one or more second users additional information relating to hunting activities relating to animals which are not of the primary target species for the tournament scoreboard in which they are participating.

11. A computer-implemented method according to claim 1, wherein the method further comprises providing a user interface for the one or more second users for each tournament scoreboard, where they may view a portion of the user data associated with the other second users participating in a shared tournament scoreboard.

12. A computer-implemented method according to claim 11, wherein the user interface also shows the region and location of the host of the tournament scoreboard.

13. A computer-implemented method according to claim 11, wherein the user interface also shows a scoring threshold and ranking of the user for that tournament scoreboard.

14. A computer-implemented method according to claim 11, wherein the user interface also shows reward distribution amounts for the tournament scoreboard based on the scoring threshold associated with the second user and their current score.

15. A computer-implemented method according to claim 1, wherein the method further comprises storing each second user's tournament history in the user database and providing a user interface where the one or more second users may view their tournament history.

16. A computer-implemented method according to claim 15, wherein the method further comprises awarding virtual badges and trophies to the one or more users upon satisfaction of predefined conditions, the virtual badges and trophies being viewable via the user interface.

17. A computer-implemented method according to claim 1, wherein the method further comprises providing a user interface where second users participating in tournament scoreboards having two or more participants and meeting one or more predefined conditions may view scores and rankings of participants of other tournament scoreboards associated with larger regions.
